(19) United States
(12) Patent Application Publication
(10) Pub. No.: US 2025/0050552 A1
(43) Pub. Date: Feb. 13, 2025

(54) METHOD OF PRODUCING THERMOPLASTIC SHEET PRODUCTS AND A CORRESPONDING PRODUCTION LINE

(71) Applicant: The Good Plastic Company International Limited, London (GB)

(72) Inventor: Nicolai TIBULEANCO, Chernivtsi (UA)

(21) Appl. No.: 18/933,669

(22) Filed: Oct. 31, 2024

Related U.S. Application Data
(63) Continuation of application No. PCT/IB2022/062911, filed on Dec. 30, 2022.

(30) Foreign Application Priority Data
Aug. 19, 2022 (UA) 2022 03007

(51) Int. Cl. B29C 43/52; B29C 43/34; B29C 43/56

(52) U.S. Cl. CPC B29C 43/52; B29C 2043/3494; B29C 2043/561

(57) ABSTRACT

A method and production line are provided for producing sheet products by thermopressing raw materials from thermoplastic plastics and may be used for manufacturing substantially flat products. The method includes thermopressing the raw materials from thermoplastic plastics under pressure to produce in at least one press, and subsequent cooling under pressure of a semi-finished sheet product in at least one other press. A mold with detachable parts may be used, starting from dosing and feeding the raw materials to thermopressing and cooling, and ending with removing a finished sheet product. A production line for producing the sheet products by thermopressing the raw materials from thermoplastic plastics is also provided.

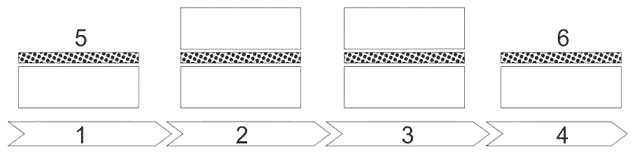

### CROSS REFERENCE TO RELATED APPLICATION

This application is a continuation of International Patent Application No. PCT/IB2022/062911, filed Dec. 30, 2022, which claims the benefit of Ukraine Patent Application No. 2022 03007, filed Aug. 19, 2022 the contents of each of which are incorporated by reference herein in its entirety.

### FIELD OF THE INVENTION

The invention relates to the field of producing sheet products by thermopressing raw materials from thermoplastic plastics and may be used for manufacturing substantially flat products, in particular, when regenerating or recycling plastic waste.

In this disclosure, the term “thermopressing” refers to the process of sintering or completely melting raw materials from thermoplastic plastic under pressure and under the influence of a certain temperature followed by cooling and producing a polymer sheet product.

One type of thermoplastic plastics such as polyethylene (PE), polypropylene (PP), polystyrene (PS), ABS plastic (ABS), polyacrylate, polyurethane and other known thermoplastic polymer materials, or a mixture of different types of thermoplastic plastics may be used as raw materials. The raw materials also refer only to thermoplastic plastics of various structures (granules, crushed particles, flakes, etc.) or thermoplastic plastics with a filler or fillers of artificial and natural origin. Reinforcing fibers (chopped glass and other fibers (carbon, organic, etc.)), randomly or specially distributed in the volume of the finished product, or dispersed reinforcing particles may be used as a filler to increase the strength and rigidity of the finished product. Also, sheet fabric or cellulose materials or mesh materials and the like may be used as fillers to give the finished product insulating properties, resistance to high temperatures, moisture resistance, etc.

In addition, the raw materials from thermoplastic plastics may be pre-impregnated with a gas agent which, upon further exposure to high temperatures, for example, in a hot press, forms cavities in the thickness of the finished product to reduce total weight thereof.

### BACKGROUND

Similar methods of production of sheet products from thermoplastic plastics and production lines are known, among which the following ones are the closest.

From document GB2350083 (B), publication date Mar. 31, 2004, a sheet product from recycled plastics is known, wherein polyethylene bags are mainly used as such ones. A method of producing this product includes compression molding of recycled plastics, for which the raw materials in the form of the mentioned polyethylene bags are arranged in overlapping layers to form a multilayer structure which is subjected to thermopressing between two heated plates until the layers are thermally welded together and a monolithic flat product is formed. Heating and pressing the multilayer structure are carried out at a temperature of 150° C. to 250° C. for 20 to 50 seconds. In addition, the appearance of the sheet product may be improved by using dyes and/or combining polyethylene bags of different colors when forming the multilayer structure. This method enables producing a relatively limited range of products due to the raw materials used in the process and is also quite complicated because of the need for forming the multilayer structure.

Also a method of thermal pressing of plates from thermoplastic materials disclosed in GB693647 (A), publication date Jul. 1, 1953, is known, wherein, at each pressing operation, one sheet is heated under pressure between hot plates and another sheet is cooled under pressure between cooling plates. The pressure heating and cooling zones are separated by insulation or an intermediate zone. Changing the heating zone and the cooling zone is performed by changing the position of the hot plates, cooling plates and sheets, which are pressed using conveyor belts for plates and movable traverses, on which the hot plates and the cooling plates are secured. The separation of heating and cooling under pressure into separate zones is an advantage of this method, however, the disadvantage is the heating of raw materials and cooling of the semi-finished plastic panel in one device, which increases energy costs for the production of plastic panels, since it does not allow to keep the heating zone with a constantly elevated temperature, and the cooling zone with a constantly reduced temperature.

A production line for producing fire-resistant fiber plates disclosed in KR100787162 (B1), publication date Dec. 24, 2007, is known, which consists of a unit for transporting fiber plate layers, a unit for introducing fiber plate layers to a hot pressing unit for heating under pressure fiber plate layers and a cold pressing unit for cooling and pressing a semi-finished plate under pressure, a means for unloading the finished plate, and a conveyor for transportation plate parts and a finished plate. The production line disclosed therein uses separate heating of raw materials and cooling of semi-finished product but is not suitable for recycling thermoplastic plastics and producing sheet products therefrom.

A method and a production line for producing plates using waste thermoplastics as raw materials (CN113478687 (A), publication date Oct. 8, 2021) are known. At the same time, the method includes pre-processing of raw materials to produce fibrous strips from a mixture of different materials, for example, polyethylene and polypropylene, followed by the formation of a mesh structure therefrom in a plate-forming machine using extrusion. Then, solidifying such a mesh structure is carried out in a hot press under pressure and at the melting temperature of the material of both types of raw materials, due to which one melt of one material penetrates into another material to form a semi-finished plate, which is then transferred to a cold press for cooling under pressure using water circulation on the cold press plates. This method is also characterized by insufficient energy efficiency because of the need for pre-processing of raw materials and the difficulty of regulating processes in the cold press due to the method of cooling thereof.

A method of producing plastic panels from thermoplastic film, in particular, from waste thereof, and an apparatus for implementing this method disclosed in DE3024229 (A1), publication date Jan. 21, 1982, are known and chosen as a prototype. According to the prototype, the method includes dosing raw materials from thermoplastic plastic to manufacture at least one sheet product, feeding the dosed raw materials for heating thereof under pressure, heating the dosed raw materials under pressure in a hot press to produce a semi-finished sheet product, feeding the semi-finished sheet product for cooling under pressure, cooling the semi-finished product under pressure in a cold press until the finished sheet product is produced. At the same time, the raw materials in the form of source thermoplastic materials are preliminarily prepared by grinding, dosed at the source material feed station, followed by feeding the raw materials to the hot press where the raw materials are heated over the entire surface of working plates thereof to a temperature of preferably more than 200° C., and pressing thereof under pressure of more than 6 kPa/cm². In order to cool the heated semi-finished plastic panel, under pressure, air is removed between the working plates of the cold press followed by separation thereof to produce a finished plastic panel. Also described is a production line for implementing the method, which includes a pressing section with heating the contents of the filled mold, provided with the hot press, and a pressing section with cooling the contents of the filled mold, provided with the cold press. The production line is provided with a conveyor for the source materials and the produced plastic sheets, extending from the source material feed station through the pressing station. The disadvantage of this method and production line is the above-described preliminary preparation of raw materials and feeding of the dosed raw materials directly onto the press plates of the hot press, as well as cooling of the semi-finished product with air removal, which reduces the energy efficiency of producing sheet products.

### SUMMARY

The disclosure of the method is based on an objective of producing sheet products from thermoplastic plastics, preferably from the waste of any thermoplastic plastics, from one type of raw materials or in a mixture, in a pure form or using fillers or impurities of artificial or natural origin, which have a small thickness and a large surface area relative to the thickness of these products. The production line is based on the objective of increasing the energy efficiency, environmental friendliness, and safety of the method of producing sheet products from thermoplastic plastics.

The objective may be addressed by the fact that the known method of producing sheet products from thermoplastic plastics, including dosing the raw materials from thermoplastic plastics for manufacturing at least one sheet product, feeding the dosed raw materials for heating thereof under pressure, heating the dosed raw materials under pressure in at least one hot press to produce a sheet product from the semi-finished product, feeding the semi-finished sheet product for cooling under pressure, cooling the semi-finished product under pressure in at least one cold press to produce a finished sheet product, for dosing the raw materials, uses a mold including at least a mutually detachable lower part of the mold and the upper part of the mold configured to cover the lower part of the mold from above. At the same time, the raw materials are dosed into the lower part of the mold in an amount required for producing the sheet product. After dosing, the lower part of the mold is covered with the upper part of the mold to manufacture a closed mold. Heating the dosed raw materials under pressure is carried out using electric heaters and working plates of the hot press, between which the closed mold with the dosed raw materials is placed, and using which pressure is applied to the dosed raw materials in the closed mold. Cooling the semi-finished product under pressure is carried out using air flow and the working plates of the cold press, between which the closed mold with the semi-finished product produced after the hot press is placed and using which pressure is applied to the semi-finished product in the closed mold. Wherein, the finished sheet product is removed by opening the upper part of the mold. At the same time, the dosed raw materials are fed for heating thereof under pressure, and the semi-finished sheet product is fed for cooling under pressure using a conveyor, on which the mold is placed.

According to one of the preferred embodiments of the method, the raw materials are dosed into the lower part of the mold by pouring them in a few layers.

According to one of the preferred embodiments of the method, after dosing, before covering the lower part of the mold with its upper part, the upper surface of the raw materials is leveled using a leveling device.

According to another preferred embodiment of the method, before dosing, the lower part of the mold is set configured to change the height of placing thereof.

According to another preferred embodiment of the method, before removing the finished sheet product, a closed mold is set configured to change the height of placing thereof.

According to another preferred embodiment of the method, heating the dosed raw material is carried out under pressure in the hot press to a temperature lower than the degradation temperature of the raw materials.

According to another preferred embodiment of the method, before heating and/or in the process of heating the dosed raw materials under pressure in the hot press, vacuuming the inner volume of the closed mold is performed.

According to another preferred embodiment of the method, the finished sheet product with a decorative pattern on at least part of the outer surface of the product is produced by using the raw materials of different colors.

According to another preferred embodiment of the method, the finished sheet product with a decorative relief texture is produced on at least part of the outer surface of the product by polishing thereof or using the lower part of the mold and/or the upper part of the mold with projections and/or depressions, which together form the decorative relief texture.

According to another preferred embodiment of the method, the cold press with a mechanical or hydraulic actuator or the cold press with a mechanical or hydraulic actuator combined with a pneumatic actuator is used.

The objective set is also solved by the fact that in the production line for producing the sheet products from thermoplastic plastics, consisting of sequentially arranged elements, including a pressing section with heating the raw materials, provided with at least one hot press, and a pressing section with cooling the semi-finished product, provided with at least one cold press, the sequentially arranged elements additionally include a section of raw material preparation and filling the mold with the raw materials, located before the pressing section with heating the raw materials, and a section for removing the finished sheet product from the mold, located after the pressing section with cooling the semi-finished product. At the same time, the section of raw material preparation and filling the mold with the raw materials is provided with a procurement table with a surface for setting the mold and a movable hopper for pouring the raw materials into the mold. The mold includes at least a mutually detachable lower part of the mold and an upper part of the mold configured to cover the lower part of the mold from above. The hot press of the pressing section with heating the raw materials and the cold press of the pressing section with cooling the raw materials are both provided with a main frame, a lower working plate configured to move up and down relative to the main frame using power pneumatic actuators to create pressure within the mold, and the upper work plate fixedly secured on the main frame. Electric heaters for heating the raw materials in the mold are located on the area of said working plates of the hot press. The cold press is provided with means of supplying cold air via the lower working plate and the upper working plate into the mold. The section for removing the finished sheet product from the mold includes a finished products table for disassembling the mold with the finished sheet product and removing thereof, provided with a surface for setting the mold with the finished sheet product. The procurement table of the section of raw material preparation and filling of the mold with the raw materials, the hot press of the pressing section with heating of the raw materials, the cold press of the pressing section with cooling the raw materials and the finished products table of the section of removing the finished sheet product from the mold are connected to each other by a conveyor laid between two frames located along said procurement table, hot press, cold press, and finished products table.

According to one of the preferred embodiments of the production line, the section of raw material preparation and filling of the mold with the raw materials is provided with the leveling device including a vibration means for leveling a layer of the raw materials in the mold.

According to another preferred embodiment of the production line, the surface of the procurement table for setting the mold is configured to move up and down.

According to another preferred embodiment of the production line, the surface of the finished products table for setting the mold with the finished sheet product is configured to move up and down.

According to another preferred embodiment of the production line, the lower part of the mold is formed by the side frame and the lower sheet connected to each other, and the upper part of the mold is formed by a removable upper sheet configured to cover the side frame from above.

According to another preferred embodiment of the production line, the lower part of the mold is formed by the lower sheet with the edges bent upwards, and the upper part of the mold is formed by the removable upper sheet configured to cover the bent edges of the lower sheet from above.

For said latter two embodiments of the production line, the inner surface of the lower part of the mold and/or the upper part of the mold may include projections and/or depressions, which together form the decorative relief texture.

According to another preferred embodiment of the production line, the latter additionally includes a compressor for supplying compressed air to said power pneumatic actuators of the procurement table, hot press, cold press, and finished products table via the compressed air supply line.

According to another preferred embodiment of the production line, the latter includes the cold press with the mechanical or hydraulic actuator or the cold press with the mechanical or hydraulic actuator combined with the pneumatic actuator.

According to another preferred embodiment of the production line, it is additionally provided with a vacuum pump configured to vacuum the inner volume of the closed mold.

By heating the raw materials from thermoplastic plastics and cooling the semi-finished product after heating in separate different devices, i.e., the hot press and the cold press, an increase in the energy efficiency of producing sheet products is achieved due to the fact that the working plates of the hot press are always heated, which reduces energy consumption, especially for the case where the same raw materials are used for manufacturing products, which allows to maintain a constant temperature of heating the working plates of the hot press during many cycles of the manufacture of products. At the same time, the use of the mold with at least two detachable parts, i.e., the lower part and the upper part, for dosing the raw materials, followed by thermopressing thereof with the dosed raw materials, allows to produce sheet products that have a small thickness and a large surface area relative to the thickness of these products, from thermoplastic plastics of any type and structure of the raw materials. Also, using the mold increases the efficiency of both the process of thermopressing under pressure in the hot press and air cooling in the cold press by heating or cooling the most inner volume of the mold rather than the surrounding environment. Moving the dosed raw materials and the semi-finished product between the elements of the production line using the mold makes it possible to increase the energy efficiency and safety of producing the sheet products. Using the power pneumatic actuators of the procurement table, hot press, cold press and finished products table in the production line also allows to increase the energy efficiency and environmental friendliness of the process. Vacuuming the inner volume of the closed mold with the vacuum pump before heating and/or during the process of heating the dosed raw materials under pressure in the hot press allows to remove unnecessary small inclusions in the raw materials, for example, dirt that may be contained in the secondary raw materials, and thereby improve the quality of the sheet products produced. Making the inner surface of the lower part of the mold and/or the upper part of the mold with projections and/or depressions which together form the decorative pattern allows to produce the finished sheet product with the decorative pattern on at least part of the outer surface of the product directly in the process of forming the sheet product, i.e., without further additional mechanical or chemical processing of the sheet product produced, thereby expanding the range of products and at the same time simplifying the method of producing the sheet products from thermoplastic plastics. Using the cold press with the mechanical or hydraulic actuator or the cold press with the mechanical or hydraulic actuator combined with the pneumatic actuator allows for quick and strong pressing the mold with the hot semi-finished product in the cold press. Only the pneumatic actuator does not allow to obtain the required dynamics of pressing the mold in the cold press due to the fact that the pressure therein increases rather slowly.

### BRIEF DESCRIPTION OF THE DRAWING

The following is an example of the production line for producing the sheet products from thermoplastic plastics and an example of producing the sheet products using this line. The example is illustrated by the general diagram of the production line. The example provided does not limit other possible embodiments of the invention but only explains its essence and confirms the possibility of implementation.

### DETAILED DESCRIPTION OF THE PREFERRED EMBODIMENTS

The production line for producing the sheet products from thermoplastic plastics has a linear layout shown in the diagram and includes the following sequentially arranged elements: the section of raw material preparation and filling the mold with the raw materials (1), the pressing section with heating the raw materials (2), the pressing section with cooling the semi-finished product (3), and the section for removing the finished sheet product from the mold (4). The diagram also shows the raw material-filled mold (5) in section (1) and the mold with the finished sheet product (6).

The mold is provided for the uniform pouring of the raw materials, melting and solidification thereof in the form of a sheet product. For this purpose, the mold (5) includes the mutually detachable lower part of the mold and upper part of the mold configured to cover the lower part of the mold from above. The preferred embodiment of this mold (5) is implementation thereof in the form of a parallelepiped. The lower part of the mold (5) is formed by the side frame connected to the lower sheet and the upper part is formed by the removable upper sheet configured to cover the side frame from above. Alternatively, the lower part of the mold (5) may be formed by the lower sheet with the edges bent upwards. In this case, the upper part of the mold (5) is formed by the removable upper sheet configured to cover the bent edges of the lower sheet from above. In order to produce the sheet products of different thicknesses, appropriate molds of the desired height are used. The mold (5) is provided with means for connection with the conveyor chains. The frame, bottom sheet, and top sheet may be configured with an inner Teflon coating or a non-adhesive coating of various types, plain or glossy. The mold (5) may also be used with the lower part and/or the upper part, the inner surface of which is provided with projections and/or depressions, which together form the decorative relief texture.

The section of raw material preparation and filling the mold with the raw materials (1) includes the procurement table which ensures placing the lower part of the mold (5) for uniformly pouring into it a layer of the raw materials of the required thickness of the pouring, and the movable hopper with the raw materials for pouring the raw materials into the mold (5), as well as the leveling device including a vibration means for leveling the layer of the raw materials in the mold (5). This vibration means may include guides and one or more shafts mounted to vibrate for leveling the layer of the raw material in the mold (5). The surface of the procurement table, on which the mold (5) is set, is configured to move up and down. The procurement table is provided with a control panel in the form of a switch for the upper or lower position of the surface, on which the mold (5) is set.

The pressing section with heating the raw materials (2) includes at least one hot press for the performing a first part of the technological cycle of producing the sheet product, i.e., melting under pressure. The pressing section with heating the raw materials (2) may include a few hot presses sequentially arranged one after the other. For melting under pressure, the hot press is provided with the main frame, lower working plate, and upper working plate fixedly secured on the main frame. The lower working plate is configured to move up and down using the power pneumatic actuators for creating pressure within the mold (5). The electric heaters for heating the raw materials in the mold (5) are located on the area of the working plates. The hot press is provided with an operator panel to control the movement of the plate, adjust the pressure amount of pressing the lower working plate and the temperature of heating the raw materials in the mold (5). The hot press is also provided with an exhaust ventilation module to provide for local ventilation in the place of release of toxic substances during thermopressing of thermoplastic materials, especially such as ABS plastic, acrylic, and the like. Also, the exhaust ventilation module should be provided with a means of disposal of harmful substances to increase the environmental friendliness and safety of the production line.

The pressing section with cooling the semi-finished product (3) includes at least one cold press for performing a second part of the technological cycle of producing the sheet product, i.e., cooling and solidification under pressure. The pressing section with cooling the semi-finished product (3) can include a few cold presses sequentially arranged one after the other. For cooling and solidification under pressure, the cold press is provided with the main frame, lower working plate, and upper working plate fixedly secured on the main frame. The lower working plate is configured to move up and down using the power actuators for creating pressure within the mold (5). The cold press provided with the mechanical or hydraulic actuator is preferably used. However, it is possible to use the cold press with the mechanical or hydraulic actuator which is combined with the pneumatic actuator. The cold press is provided with the means of supplying cold air via the lower working plate and the upper working plate into the mold (5). The cold press is provided with an operator panel to control the movement of the plate, adjust the pressure amount of the lower working plate and the intensity of blowing with cold air.

The lower working plate and the upper working plate of said hot press and/or cold press are preferably made of aluminum or alloys thereof due to high thermal conductivity and strength.

The section for removing the finished sheet product from the mold (4) includes the finished products table, on which the mold with the finished sheet product (6) is disassembled and removed. The finished products table includes the main frame, on which a surface is set for setting the mold with the finished sheet product (6) configured to move with the possibility of movement up and down due to the pneumatic power elements with manual control. The finished products table includes a control panel in the form of a switch for the upper or lower position of the moving surface.

The procurement table of the section of raw material preparation and filling of the mold (1) with the raw materials, the hot press of the pressing section with heating of the raw materials (2), the cold press of the pressing section with cooling the semi-finished product (3), and the finished products table of the section of removing the finished sheet product from the mold (4) are connected to each other by an actuator chain conveyor laid between two frames located along said tables and presses. On the leading side of the conveyor, on the cross beam, an electric actuator with synchronous transmission of rotation to leading sprockets on both sides of the conveyor is set. The conveyor is provided with a mold edge sensor to stop the conveyor during the mold movement and stop it at the location of the hot press, cold press, and finished products table, respectively, and an electric actuator control panel.

The production line is also provided with a vacuum pump located between the section of raw material preparation and filling the mold with the raw materials (1) and the pressing section with heating the raw materials (2). The vacuum pump is configured to vacuum the inner volume of the closed mold (5).

The production line additionally includes the compressor for supplying said power pneumatic actuators of the presses and tables with compressed air via the compressed air supply line. Said compressor is configured to automatically maintain the predetermined pressure in the compressed air supply line.

The production line for producing the sheet products from thermoplastic plastic also includes vacuum fixers for transporting the finished sheet products which consist of suction cups and the vacuum pump for pumping air between the suction cups and the surface of the finished sheet product. Each suction cup is provided with a clamping membrane, on the other side of which a handle for gripping a vacuum fixer is set, the vacuum pump, and a battery for operation thereof.

The method of producing the sheet products from thermoplastic plastics using said production line is implemented as follows.

First, in section of raw material preparation and filling the mold with the raw materials (1), raw materials are mixed to produce the desired pattern (pattern) of the surface of the sheet product. When mixing, the raw materials of different colors may be used to achieve additional design effects and produce the already finished sheet product with the decorative pattern. Any thermoplastic plastics are used as raw materials, they may include dried waste of the materials such as polyethylene (PE), polypropylene (PP), polystyrene (PS), ABS plastic (ABS), polyacrylate, polyurethane, and other thermoplastic polymer materials of various structures (granules, crushed particles, flakes, etc.).

Next, the lower part of the mold (5), i.e., the side frame with the attached lower sheet, is set on the moving surface of the procurement table of the section of raw material preparation and filling the mold with the raw materials (1). The lower part of the mold (5) is chosen with a thickness corresponding to the thickness of the desired sheet product. Using the control panel of the procurement table, the desired height of placing the mold is set for the convenience of pouring the raw materials. The desired thickness of pouring the raw materials into the mold is also set. The raw materials prepared on the previous step are poured into the movable hopper in the amount required for manufacturing the sheet product, preferably in an amount that slightly exceeds the amount required for the set thickness of pouring. By moving the movable hopper, the lower part of the mold (5) is filled with a uniform layer of the raw materials with a height, for example, 1.5 . . . 2.5 times greater than the set collapsible frame of the mold. Alternatively, the lower part of the mold (5) may be filled with the raw materials in a few layers, one layer of the raw materials per one movement of the movable hopper, the next layer for another movement of the hopper, etc. There may be a few layers of the raw materials of the same type or different types, for example, of different type, composition, structure, color, etc. Next, the upper surface of the raw materials is leveled using the leveling device and, if necessary, the excess remains of the raw materials are removed from the edges of the mold. After pouring the raw materials, it is covered with the upper part of the mold, i.e., the upper sheet. The mold (5) closed in this way and filled with the raw materials is fed to the hot press of the pressing section with heating the raw materials (2) using the chain conveyor.

On the operator panel of the hot press, the raw materials heating parameters are set (depending on the type of material, structure, thickness of the poured layer thereof). Heating is carried out using the electric heaters located over the entire area of both working plates to a temperature that is lower than the degradation temperature of the raw materials, preferably to a range of 100° C. to 350° C., more specifically, to a range of 230° C. to 300° C. When the set temperature is reached, the hot press is closed and using lifting the movable lower working plate of the hot press, pressure of the desired amount is created on the raw materials within the closed mold. After that, the predetermined temperature and pressure are automatically maintained using the operator panel. The residence time of the closed mold with the raw materials in the hot press is that required for the complete melting of the raw materials. Depending on the type and thickness of the raw materials, this time is chosen from at least 5 minutes, preferably in a range of 20 to 50 minutes, and is controlled using a timer. After the end of the melt cycle, the press is opened by lowering the lower working plate. After the press is fully opened, the mold with the semi-finished sheet product is moved to the cold press of the pressing section with the cooling of the semi-finished product (3) using the chain conveyor.

Upon arrival of the mold with the semi-finished product, the cold press is closed and, using lifting of the movable lower working plate of the cold press, pressure of the desired amount is created on the semi-finished product within the mold, which is then automatically maintained using the operator panel of the cold press. At the same time, the semi-finished product is cooled using an intensive flow of air supplied through both working plates using the means of supplying cold air. The time of exposure of the mold with the semi-finished product is such that is required for complete solidifying thereof. Depending on the type and thickness of the raw materials, this time is chosen in a range of at least 5 minutes, preferably in a range of 20 to 50 minutes. Upon ending the cooling cycle, the temperature of the semi-finished product is in a range of 40° C. to 60° C., and then the press is opened by lowering the lower working plate. After the press is fully opened, the mold with the finished sheet product (6) is moved to the section of removing the finished sheet product from the mold (4) using the chain conveyor.

The mold with the finished sheet product (6) is placed on the moving surface of the finished products table and, using the control panel, the height of placing the moving surface with the mold is chosen to facilitate disassembly thereof and removal of the finished sheet product. To disassemble the mold, the top sheet is removed using the vacuum fixers, using which the finished sheet product is also removed from the mold and transferred further to intermediate processing to remove burr and remains of the material, as well as to further processing (if necessary) or packaging. For example, the outer surface of the product or at least part thereof may be polished to produce the finished product with the decorative relief texture. The decorative relief texture can also be achieved by using the lower part of the mold and/or the upper part of the mold with projections and/or depressions, which together form the decorative relief texture. The mold without the finished product is cleaned from the remains of the material from the previous process and returned to the section of raw material preparation and filling the mold with the raw materials (1).

Thus, the finished sheet products, preferably in the form of a parallelepiped, with a small thickness and a large surface area relative to the thickness, are produced by thermopressing, for example, the sheets from thermoplastic plastic with a predetermined design and pattern of the surface or part thereof (in the case of using the raw materials of different colors), with a thickness in a range of preferably 5 to 40 mm.

What is claimed is:

1. A method of producing sheet products from thermoplastic plastics, comprising:
dosing raw materials from thermoplastic plastics for manufacturing at least one sheet product,
feeding the dosed raw materials for heating thereof under pressure,
heating the dosed raw materials under pressure in at least one hot press to produce a semi-finished sheet product,
feeding the semi-finished sheet product for cooling under pressure,
cooling of the semi-finished product under pressure in at least one cold press to produce a finished sheet product,
wherein for dosing the raw materials, a mold is used, comprising at least a mutually detachable lower part of the mold and an upper part of the mold configured to cover the lower part of the mold from above,
dosing the raw materials is carried out into the lower part of the mold in the amount required for manufacturing the sheet product,
after dosing, covering the lower part of the mold with the upper part of the mold is performed to produce a closed mold,
heating the dosed raw materials under pressure is performed using electric heaters and working plates of the hot press, between which the closed mold with the dosed raw materials is placed and using which pressure is applied to the dosed raw materials in the closed mold, and
cooling the semi-finished product under pressure is performed using air flow and working plates of the cold press, between which the closed mold with the semi-finished product produced after the hot press is placed and using which pressure is applied to the semi-finished product in the closed mold,
wherein removing the finished sheet product is carried out by opening the upper part of the mold,
wherein feeding the dosed raw materials is performed for heating thereof under pressure and feeding the semi-finished sheet product is performed for cooling under pressure using a conveyor, on which the mold is placed.

2. The method of claim 1, wherein the raw materials are dosed into the lower part of the mold by pouring thereof in a few layers.

3. The method of claim 1, wherein, after dosing before covering the lower part of the mold with the upper part thereof, the upper surface of the raw materials is leveled using a leveling device.

4. The method of claim 1, wherein, before dosing, the lower part of the mold configured to change the height of placing thereof is set.

5. The method of claim 1, wherein, before removing the finished sheet product, the closed mold configured to change the height of placing thereof is set.

6. The method of claim 1, wherein heating the dosed raw material is carried out under pressure in the hot press to a temperature lower than the degradation temperature of the raw materials.

7. The method of claim 1, wherein, before heating or in the process of heating the dosed raw materials, under pressure in the hot press, vacuuming the inner volume of the closed mold is performed.

8. The method of claim 1, wherein the finished sheet product with a decorative pattern on at least part of the outer surface of the product is produced by using the raw materials of different colors.

9. The method of claim 1, wherein the finished sheet product with a decorative relief texture is produced on at least part of the outer surface of the product by polishing thereof or using the lower part of the mold and/or the upper part of the mold with projections and/or depressions, which together form the decorative relief texture.

10. The method of claim 1, wherein the cold press with a mechanical or hydraulic actuator or the cold press with a mechanical or hydraulic actuator combined with a pneumatic actuator is used.

11. A production line for producing sheet products from thermoplastic plastics, consisting of sequentially arranged elements, comprising:
a pressing section with heating raw materials, provided with at least one hot press, and
a pressing section with cooling a semi-finished product, provided with at least one cold press,
wherein the sequentially arranged elements additionally comprise a section of raw material preparation and filling a mold with the raw materials located before the pressing section with heating the raw materials, and a section for removing a finished sheet product from the mold located after the pressing section with cooling the semi-finished product,
the section of raw material preparation and filling of the mold with raw materials is provided with a procurement table with a surface for setting the mold and a movable hopper for pouring the raw materials into the mold,
the mold comprises at least a lower part of the mold and an upper part of the mold mutually detachable, configured to cover the lower part of the mold from above,
the hot press of the pressing section with heating the raw materials and the cold press of the pressing section with cooling the raw materials are both provided with a main frame, a lower working plate configured to move up and down relative to the main frame using power pneumatic actuators to create pressure within the mold and an upper working plate fixedly secured on the main frame, wherein electric heaters are placed on the area of said working plates of the hot press for heating the raw materials in the mold, and
the cold press is provided with means of supplying cold air through the lower working plate and the upper working plate into the mold,
wherein the section of removing the finished sheet product from the mold comprises a finished products table for disassembling the mold with the finished sheet product and removing thereof, provided with a surface for setting the mold with the finished sheet product, and
a procurement table of the section of raw material preparation and filling the mold with the raw materials,
the hot press of the pressing section with heating the raw materials, the cold press of the pressing section with cooling the raw materials, and the finished products table of the section of removing the finished sheet product from the mold are connected to each other by a conveyor laid between two frames located along said procurement table, hot press, cold press, and finished products table.

12. The production line of claim 11, wherein the section of raw material preparation and filling the mold with the raw materials is provided with a leveling device including a vibration means for leveling a layer of the raw materials in the mold (5).

13. The production line of claim 11, wherein the surface of the procurement table for setting the mold is configured to move up and down.

14. The production line of claim 11, wherein the surface of the finished products table for setting the mold with the finished sheet product is configured to move up and down.

15. The production line of claim 11, wherein the lower part of the mold is formed by the side frame and the lower sheet connected to each other, and the upper part of the mold is formed by a removable upper sheet configured to cover the side frame from above.

16. The production line of claim 11, wherein the lower part of the mold formed by the lower sheet with the edges bent upwards, and the upper part of the mold is formed by the removable upper sheet configured to cover the bent edges of the lower sheet from above.

17. The production line of claim 11, wherein the inner surface of the lower part of the mold or the upper part of the mold comprises projections or depressions, which together form the decorative relief texture.

18. The production line of claim 11 further comprising a compressor for supplying compressed air to said power pneumatic actuators of the procurement table, hot press, cold press, and finished products table via the compressed air supply line.

19. The production line of claim 11 further comprising the cold press with a mechanical or hydraulic actuator or the cold press with a mechanical or hydraulic actuator combined with a pneumatic actuator.

20. The production line of claim 11 further comprising a vacuum pump configured to vacuum the inner volume of the closed mold.
